(19) United States
(12) Patent Application Publication
(10) Pub. No.: US 2002/0087191 A1
(43) Pub. Date: Jul. 4, 2002

(54) Protective pacifier nipple structure

(76) Inventor: Te-Ta Huang, Chang hua Hsien (TW)

Correspondence Address: DOUGHERTY & TROXELL, SUITE 1404, 5205 LEESBURG PIKE, FALLS CHURCH, VA, 22041, US

(21) Appl. No.: 09/752,686

(22) Filed: Jan. 3, 2001

(51) Int. Cl. A61J 17/00

(52) U.S. Cl. 606/236

(57) ABSTRACT

A protective pacifier nipple structure comprised of a nipple and a protective sleeve installed over the exterior section of the nipple. The nipple has situated at one side a nursing end and at the other side a round stay and, furthermore, disposed on the round stay is a grasping ring. The present invention includes the following innovative features. The round stay has fitted onto its outer periphery a protective sleeve. The said protective sleeve consists of a serpentine tubular structure surrounding the nipple and, furthermore, formed at the tail end of the protective sleeve and aligned with the position of the nursing end is a through-hole. When the protective sleeve is collapsed, the nursing end of the nipple projects outside the through-hole and provides for the suckling of the infant. When the nipple is removed from the mouth of the infant, the protective sleeve is no longer compressed and the serpentine tubular structure elastically returns to its original shape, once again surrounding the nursing end of the nipple. As such, when the pacifier nipple is dislodged, the nursing end is prevented from contacting the floor, thereby functioning as a hygienic and safe protective pacifier nipple structure.

### BACKGROUND OF THE INVENTION

1) Field of the Invention

The invention herein relates to a protective pacifier nipple structure in which the nipple has fitted to the outer periphery of its round stay a protective sleeve that surrounds the nipple and, furthermore, is of a serpentine tubular structure; formed at the tail end of the protective sleeve and aligned with the position of the nursing end is a through-hole; as such, when the protective sleeve is collapsed, the nursing end of the nipple projects outside the through-hole and provides for the suckling of the infant; when the nipple is removed from the mouth of the infant, the protective sleeve immediately returns to its original shape, once again surrounding the nursing end of the nipple, such that when the pacifier nipple is dropped, the nursing end is prevented from contacting the floor, thereby functioning as a hygienic and safe protective pacifier nipple structure.

2) Description of the Prior Art

According to statistics, when sucking a nursing nipple, an infant is pacified and calmed and, moreover, crib death is averted; as such a nursing nipple is an indispensable infant product; however, as the infant is sucking the nipple, it is frequently expectorated unintentionally and falls onto the floor or is easily dropped due to imprudence by parents during removal; since in conventional nipple-type pacifiers, the nursing end of the nipple is directly exposed externally, the nursing end makes direct contact with the floor upon falling, becoming covered with unclean substances and bacteria such that when use of the pacifier is resumed, the frail still unvaccinated infant is subjected to contagious pathogens and the resultant diseases thereof

In view of the said situation, the inventor of the invention herein conducted research, development, and design along with repeated testing and improvements that culminated in the successful development of the protective pacifier nipple structure of the present that entirely eliminates the drawbacks of the conventional product and, furthermore, is capable of significantly greater practicality.

### SUMMARY OF THE INVENTION

The primary objective of the invention herein is to provide a protective pacifier nipple structure comprised of a nipple and a protective sleeve installed over the exterior section of the nipple, wherein the nipple has situated at one side a nursing end and at the other side a round stay; the round stay has fitted onto its outer periphery a protective sleeve, the said protective sleeve consisting of a serpentine tubular structure surrounding the nipple and, furthermore, formed at the tail end of the protective sleeve and aligned with the position of the nursing end is a through-hole; when the protective sleeve is collapsed, the nursing end of the nipple projects outside the through-hole and provides for the suckling of the infant, when the nipple is removed from the mouth of the infant, the protective sleeve is no longer compressed and the serpentine tubular structure instantly returns to its original shape, once again surrounding the nursing end of the nipple; and, as such, when the pacifier nipple is dislodged, the nursing end is prevented from contacting the floor, thereby functioning as a hygienic and safe protective pacifier nipple structure.

To enable a further understanding of the technological means, the resultant functions, and objectives of the invention herein, the general embodiment of the present invention is elaborated by the brief description of the drawings below and followed by the detailed description of the invention herein.

### BRIEF DESCRIPTION OF THE DRAWINGS

FIG. 1 is an exploded drawing of the invention herein.

FIG. 2 is an isometric drawing of the invention herein.

FIG. 3 is a cross-sectional drawing of the invention herein.

FIG. 3-A is an orthographic drawing of the invention herein after compression.

FIG. 4 is an orthographic drawing of the invention herein in a state of utilization.

### DETAILED DESCRIPTION OF THE INVENTION

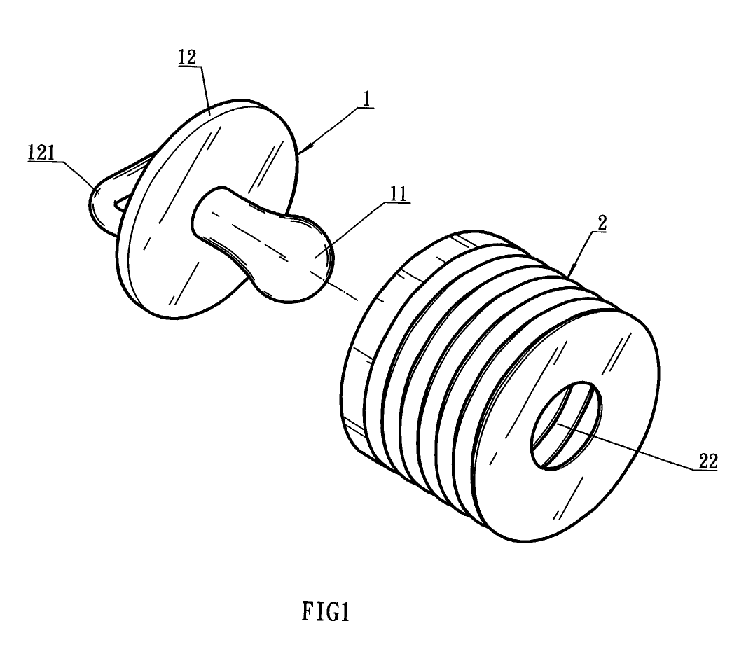

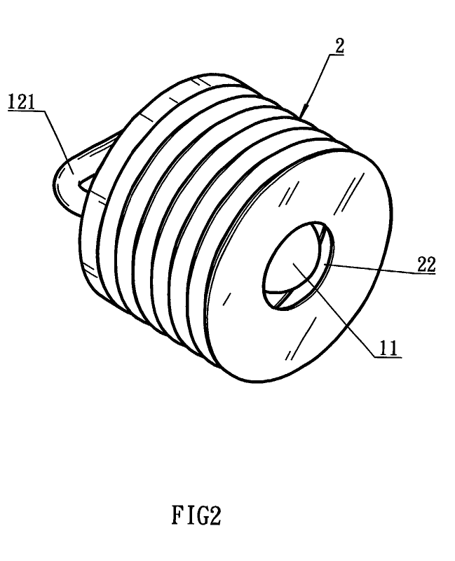

Referring to FIG. 1 and FIG. 2, the drawings of the structural arrangement of the present invention, the invention herein is comprised of a nipple 1 and a protective sleeve 2 installed over the exterior section of the nipple 1, of which:

The said nipple 1 has situated at one side a nursing end 11 an at the other side a round stay 12 and, furthermore, disposed on the round stay 12 is a grasping ring 121.

The said protective sleeve 2 consists of a serpentine tubular structure surrounding the nipple 1 and having formed inside one end an annular engagement groove 21 and, furthermore, the annular engagement groove 21 is fitted onto the outer periphery of the round stay 12 of the nipple 1, with the other end having a through-hole 22 aligned with the position of the nursing end 11.

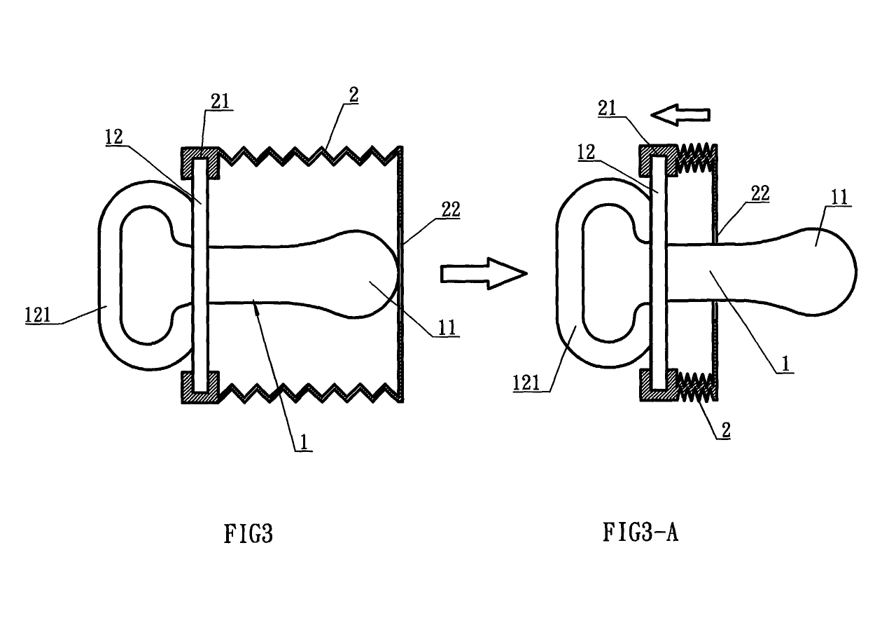

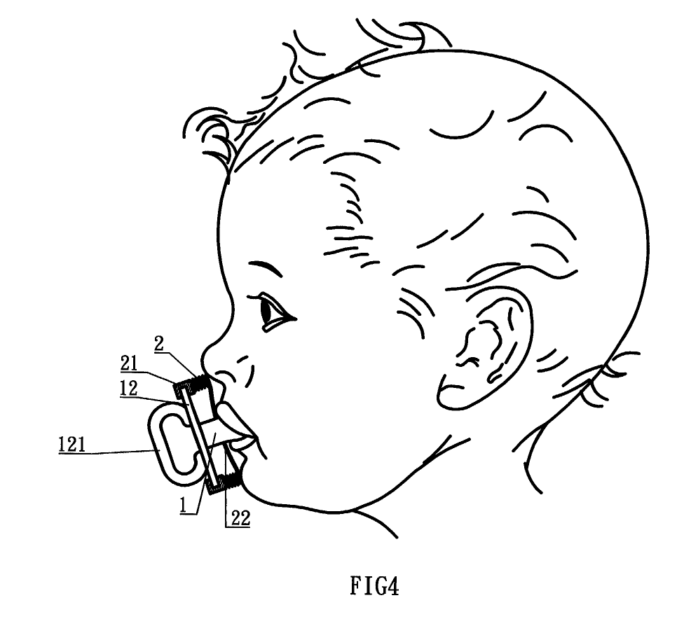

Referring to FIG. 3 and FIG. 4, when the protective sleeve 2 is collapsed, the nursing end 11 of the nipple 1 projects outside the protective sleeve 2 through-hole 22 and provides for the suckling of the infant.

When the nipple 1 is removed from the mouth of the infant, the protective sleeve 2 is no longer compressed and the serpentine tubular structure immediately returns to its original shape, once again surrounding the exterior of the nipple 1 nursing end 11, as indicated in FIG. 3-A, such that when the pacifier nipple is dislodged, the nursing end 11 is prevented from contacting the floor, thereby functioning as a hygienic and safe protective pacifier nipple structure.

In summation of the foregoing section, since the protective pacifier nipple structure of the invention herein is capable of achieving of the claimed objectives, provides increased practical functionality that exceeds that of the conventional product and, furthermore, no product of similar structural features has been observed for public sale, the present invention meets new patent application requirements and is lawfully submitted for review and the granting of the commensurate patent rights in accordance with the spirit of the patent law encouraging the promotion of legitimate invention.

1. A protective pacifier nipple structure comprised of nipple having situated at one side a nursing end and at the other side a round stay and, furthermore, disposed on the said round stay is a grasping ring.
The innovative features of the invention herein include: The said round stay has attached to it a protective sleeve, the said protective sleeve consists of a serpentine tubular structure surrounding the said nipple and, furthermore, formed at the tail end of the said protective sleeve and aligned with the said nursing end is a through-hole such that when the said protective sleeve is collapsed, the said nursing end of the said nipple projects outside the said through-hole and provides for the suckling of the infant; as such, when the pacifier nipple is dislodged, the said nursing end is prevented from contacting the floor, thereby functioning as a hygienic and safe protective pacifier nipple structure.

2. As mentioned in claim 1 of the protective pacifier nipple structure of the invention herein, the said protective sleeve has formed inside one end an annular engagement groove and, furthermore, the said annular engagement groove is fitted onto the outer periphery of the said round stay of the said nipple.
